(19) United States
(12) Patent Application Publication
(10) Pub. No.: US 2016/0012557 A1
(43) Pub. Date: Jan. 14, 2016

(54) SYSTEM AND METHOD FOR SCORING OF A NEW IDEA

(71) Applicant: Anurakt Dixit, Plano, TX (US)

(72) Inventor: Anurakt Dixit, Plano, TX (US)

(21) Appl. No.: 14/664,860

(22) Filed: Mar. 22, 2015

Related U.S. Application Data
(60) Provisional application No. 62/022,626, filed on Jul. 9, 2014.

(51) Int. Cl. G06Q 50/18; G06F 17/30

(52) U.S. Cl. CPC G06Q 50/184; G06F 17/30864

(57) ABSTRACT

A system for scoring of a new idea comprising a client device, a search engine source, and a computer system communicatively connected to the client device through a network. The computer system have one or more modules and the modules are configured to execute receiving of details of an idea from a user through the client device, searching for existence of idea similar to said idea, providing of information on a result of the search to the user through the client device and providing of suggestion based on the result to the user through the client device.

### CROSS REFERENCE TO RELATED APPLICATION

This Non-Provisional Utility patent application claims the benefit of the filing date of U.S. Provisional Patent Application No. 62/022,626 filed Jul. 9, 2014 titled “A SYSTEM AND METHOD FOR SCORING OF A NEW IDEA” which is herein incorporated by reference.

### FIELD OF THE INVENTION

The present invention generally relates to a scoring engine. More particularly, the present invention relates to scoring of novelty and success probability of a new idea and providing associated guidance to turn the idea into reality.

### BACKGROUND OF THE INVENTION

Innovation is important in facilitating economic growth, enhancing standards of living, spreading creativity and the arts. People have lot of innovative ideas but have no way of knowing if their idea is original and what are the chances of this idea being successful, if pursued today. The cost of search and amount of information lying around makes the task very cumbersome. This ‘fear to failure’ leads to many ideas getting dropped and the world is devoid of ideas which could have been beneficial to everyone. An idea or concept for innovation has several road blocks with many open questions about its success and relevance.

One of the unresolved problems in today's world is of ‘fear to failure’. Therefore, there is a need for a system that will give a detailed analysis on comparing where one's idea or concept would stand in today's world. As can be seen there is a need for a system that determines success probability by providing a score to the idea and that provide information about any current ongoing work on that idea and guide the inventor to turn the idea into reality.

### OBJECTS OF THE INVENTION

An object of the present invention is to provide a system for scoring of a new idea which predicts potential success of a new idea.

Another object of the present invention is to provide a system for scoring of a new idea which provides education to the inventors.

A further object of the present invention is to provide a system for scoring of a new idea which gives confidence to the inventor to move forward and pursue his/her idea.

A still further object of the present invention is to provide a system for scoring of a new idea which provides a platform to investors and inventors to contribute and pursue the ideas.

Yet another object of the present invention is to provide a system for scoring of a new idea which will generate a summary of how world thinks on a subject and idea and how much worth is in pursuing the idea.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Accordingly, there is provided a system for scoring of a new idea which uses a special logic and algorithm to understand an idea via a software system. In accordance with one embodiment of the present invention, the algorithm is based on a mathematical equation, a semantic analytics service for contextual analysis and scrapping of multiple sources and comparing them to understand how closely they are related to a new idea of a user via a software system.

The system for scoring of a new idea of the present invention enables a user to describe his/her idea through a Graphical User Interface (GUI) presented on a display of a client device. The system of the present invention promises confidentiality to the user about his/her idea by providing a non-disclosure agreement to the user before he/she enters his/her idea to the system. The system provides an Invention Disclosure Form to be filled up in order to disclose the idea by the user. As soon as the user submits the required information asked by the system, the scoring action is done by the system and the user is informed about the probabilities of getting a patent on the idea. The user is given guidance on the steps to be taken for commercialization of the idea and also provided the opportunity to connect with different members who are registered with the website provided by the system who can help him/her to make the idea into reality. The user can ask the system for further details, can make minor changes in his/her idea and ask the system for re-evaluation.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 shows a general architecture of a system that operates in accordance with one embodiment of the present invention;

FIG. 2 illustrates a flowchart depicting the principal operations in accordance with one embodiment of the present invention;

FIG. 3 illustrates a flowchart depicting the principal operations in conjunction with FIG. 2 in accordance with one embodiment of the present invention; and

FIG. 4 illustrates a flowchart depicting the principal operations in conjunction with FIG. 2 and FIG. 3 in accordance with one embodiment of the present invention.

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “determining”, “calculating” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Embodiments of the present invention are described herein in the context of a system and a method for scoring of a new idea. A computing system, software and an algorithm works together to score an idea based on a description submitted made by a user. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

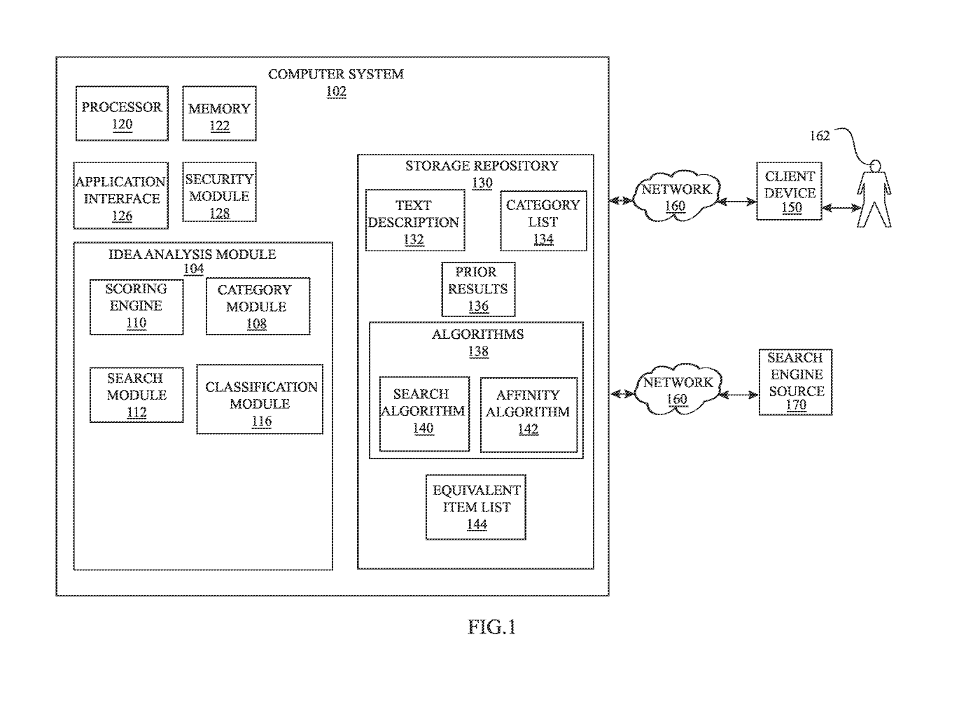

FIG. 1 shows a diagram of a system in accordance with one or more embodiments of the invention. The system includes a computer system (102), a client device (150) and one or more search engine source (170). The computer system (102) includes an idea analysis module (104), a storage repository (130), a processor (120), memory (122), an application interface (126), and, optionally, a security module (128). The idea analysis module (104) includes a classification module (116), a category module (108), a scoring engine (110) and a search module (112). The storage repository (130) includes text descriptions (132), category lists (134), prior results (136), algorithms (138) and equivalent items lists (144). The algorithms (138) include search algorithms (140) and affinity algorithms (142). Each of these components is described below. Embodiments of the invention are not limited to the configuration shown in FIG. 1 and discussed herein.

In one or more embodiments of the invention, the computer system (102) is implemented according to a client-server topology. The computer system (102) may correspond to enterprise software running on one or more servers, and in some embodiments may be implemented as a peer-to-peer system, or resident upon a single computing system. In addition, the computer system (102) may be accessible from other machines using one or more application programming interfaces and/or user interfaces. In one or more embodiments of the invention, the computer system (102) may be accessible over a network connection (160), such as the Internet, by one or more users. Further, information and/or services provided by the computer system (102) may also be stored and accessed over the network connection.

Alternatively or additionally, in one or more embodiments of the invention, the computer system (102) may be a local computer system of the user of the system. In such embodiments, the computer system (102) may, optionally, not be implemented using a client-server topology. For example, the computer system (102) and client device (150) may correspond to a laptop computer, desktop computer, mobile device, smartphones, or another type of computing device, or combination of multiple computing devices. Additionally or alternatively, the computer system (102) may be a distributed computer system and/or multi-processor computer system in which the computer system includes multiple distinct computing devices.

Continuing with FIG. 1, the computer system (102) uses one or more search engine sources (170) to find patent literature, non-patent literature and other information which are available online from databases around the world.

In one or more embodiments of the invention, the client device (150) may interact with the computer system (102). Specifically, the user (162) may enter details of one or multiple ideas (e.g., a text description, image, and video related to the idea), user preferences, settings, and/or feedback on the website provided by the computer system (102) on the client device (150). The user (162) may send description of an idea, user preferences, settings, and/or feedback to the computer system (102) through network (160) from client device (150). The client device (150) may use a user system (not shown) to interact with the computer system (102) using software (not shown) in accordance with one or more embodiments of the invention. As is used herein, the term “website” includes Graphical User Interface (GUI) presented by the computer system (102) on any mobile device such as smart phones through an application also.

In one or more embodiments of the invention, each search engine source (170) sends patent and non-patent literature and other information (e.g., text description, image, video etc.) and receives information (e.g., a request for search of document etc. related to an idea) from, the computer system (102). Each search engine source (170) may interact with the computer system (102) in the same mode of communication that the computer system (102) interacts with a search engine source (170), or using different modes of communication.

The computer system (102) may also be implemented as a browser extension. In such a scenario, user software and search engine source software may interact directly with the computer system (102) as a browser extension.

Continuing with FIG. 1, the computer system (102) is configured to interact with the client device (150) and each search engine source (170) using an application interface (126) in accordance with one or more embodiments of the invention. Specifically, the application interface (126) of the computer system (102) is configured to receive input from and send output to the client device (150) and each search engine source (170). The client device (150) and each search engine source (170) may include an interface to receive data from and send data to the computer system (102). Examples of an interface may include, but are not limited to, a graphical user interface, an application programming interface, a keyboard, a monitor, a mouse, a web service, a data protocol adapter, some other hardware and/or software, or any suitable combination thereof.

In one or more embodiments of the invention, the information (i.e., data) transferred among the application interface (126), the client device (150) and each search engine source (170) corresponds to metadata associated with details of an idea, user preferences, settings, feedback, and/or advertisements. In this case, the metadata may describe the data specified in the details of an idea, user preferences, settings, feedback, and/or advertisements (i.e., the metadata may provide context for the specified data). In one or more embodiments of the invention, the computer system (102) is configured to support various data formats provided by the client device (150) and each search engine source (170).

Continuing with FIG. 1, the computer system (102) is configured to retrieve and store text descriptions (132), category lists (134), prior results (136), algorithms (138) and equivalent item lists (144). More specifically, the computer system (102) may be configured to retrieve and store text descriptions (132), category lists (134), prior results (136), algorithms (138) and equivalent item lists (144) in the storage repository (130) in accordance with one or more embodiments of the invention.

In one or more embodiments of the invention, a text description includes one or more words that describe the idea of the user (162). The text descriptions (132) of the storage repository (130) may include one or more text descriptions of one or more ideas entered by past users that have been previously categorized. Specifically, in one or more embodiments of the invention, each text description (132) provides an original text description of an item involved in a transaction and a search term used to categorize the item.

In one or more embodiments of the invention, the category lists (134) include a list of categories used when classifying an idea. Specifically, each category list may be used to determine which categories are searched with a search term. A category may be a word or term used to identify a classification within a system.

In one or more embodiments of the invention, a category is part of a taxonomy. A taxonomy may be a hierarchy of categories. In other words, a category in a taxonomy may include one or more subcategories. A category may be defined by one of a number of category types. For example, a category may be defined by a product (e.g., mobiles) with subcategories (e.g., wireless charger, Bluetooth, display etc.) for one or more of the categories. Categories defined by product may be based on a code (e.g., the International Patent Classification Code). With respect to the taxonomy, categorizing by subcategory may allow the user to better track certain ideas.

In one or more embodiments of the invention, the results provided by the computer system (102) against submission of an idea by a user (162) are in terms of numerical scores. The results may be generated for one or more users using the input description about an idea, search results provided by one or more search engine source (170), text descriptions (132), category lists (134), algorithms (138) and equivalent item lists (144).

In one or more embodiments of the invention, the algorithms (138) include procedures used to conduct a search, use natural language processing (NLP) and to calculate an affinity score by scoring engine (110). In one or more embodiments of the invention, algorithm(s) are stored in the storage repository as software code in a software library, configuration parameters, definition file or in another computer readable format. In one or more embodiments of the invention, an algorithm includes a procedure when the algorithm includes an identifier of software code for performing the steps, directly includes the series of steps, and/or may include other identifiers of the procedure.

The search algorithms (140) may include one or more procedures that may be used to extract key words or search terms from description provided by user (162), conduct a search based on key words, compare input with search results found and score based on relatedness. Each search algorithm (140) may include a procedure used to conduct a search for at least one search term and at least one category. Specifically, for a given search term and/or category (or set of categories), a search algorithm (140) may use one or more search engine sources (e.g., Internet search engines like Google) for conducting a search. A search engine may be a software program designed to search and gather information from one or more databases. The information gathered from the one or more databases may be based on one or more search terms. A search engine may search patent databases, web pages, books, magazine articles, and/or other references.

In one or more embodiments of the invention, the search engine source(s) (170) used by a search algorithm are determined, in part, based on the search term (derived from the text, image, audio or video description of the idea entered by the user 162) and/or the set of named categories. A named category is selected by the category module from a list of all categories. Each named category is determined to have a strong likelihood of being the category to which the search term is classified. As described below, the named categories may further be filtered at times. Ultimately, the category module selects the set of named categories to include the named categories deemed most likely to provide the correct category in which to classify the idea.

In one or more embodiments, the affinity algorithms (142) of the algorithms (138) in the storage repository (130) include a procedure used to calculate an affinity score with the help of scoring engine (110). Specifically, each affinity algorithm (142) may determine how an affinity score is calculated using the results of the search conducted using a search algorithm (142) and scoring engine (110). An affinity score may be an indication of the correlation between a search term and a search result. An affinity score may be a number (e.g., 0.9, −0.75), a range of numbers, a letter, a word or set of words (e.g., strong match, unlikely match), a category, some other suitable indication, or any combination thereof. An affinity algorithm (144) may be a mathematical formula.

In one or more embodiments of the invention, the equivalent item lists (144) include one or more equivalent items for an item involved in an idea. The equivalent item lists (144) may include equivalent items that are more general than, equivalent to, and/or more narrow than the terms used by the user (162) in his/her description about the idea.

Continuing with FIG. 1, the storage repository (130) is a persistent storage device (or set of devices) that stores software and data. In one or more embodiments of the invention, the storage repository (130) is configured to store the text descriptions (132), category lists (134), prior results (136), algorithms (138) and equivalent item lists (144) in accordance with one or more embodiments of the invention. Examples of a storage repository (130) include, but are not limited to, a database (or a number of databases), a file system, a hard drive, some other form of data storage, or any suitable combination thereof. The storage repository (130) may be located on multiple physical machines, each storing all or a portion of the text descriptions (132), category lists (134), prior results (136), algorithms (138) and equivalent item lists (144). Each storage unit or device may be physically located in the same or different geographic location.

The storage repository may be operatively connected to the idea analysis module (104). In one or more embodiments of the invention, the idea analysis module (104) includes functionality to classify an idea using a search engine. More specifically, the idea analysis module (104) may be configured to receive, for example, details of an idea, user preferences, settings, feedback, and advertisements from the application interface (126) and store the text descriptions, image, video, category lists, prior results, algorithms (such as search algorithms and affinity algorithms) and equivalent item lists in the storage repository (130).

Continuing with FIG. 1, in a preferred embodiment of the present invention, the classification module (116) is configured to receive a text description for a search term. In one or more embodiments of the invention, a search term is a grouping of one or more words, derived from the text description of the idea of the user (162), for input into a search engine. Specifically, a search term as used herein includes single words and search phrases. The search term may be a simplified version of the text description. The search term may be the same as the text description. A search term may be narrow or broad. A search term that is too narrow may not result in a correct or accurate scoring of an idea.

In one or more embodiments of the invention, the classification module (116) uses one or more algorithms to generate a search term from the text description. Examples of an algorithm include, but are not limited to, removing from the text description common words (e.g., the, a, an), removing adjectives, and removing prepositional phrases. For example, the classification module (116) may receive a text description of “a wireless charger for the mobile devices” as details of an idea entered by a user (162). In such a case, an algorithm may be used by the classification module (116) to generate a search term of “wireless charger mobile device” The classification module (116) may also use text descriptions (132) and/or prior results (136) from the storage repository (130), in conjunction with or independently of an algorithm, to generate a search term from the text description.

In one or more embodiments of the invention, the classification module (116) is further configured to select an affinity algorithm to be used in calculating one or more affinity scores based on a comparison between details entered by user with search results. Specifically, the classification module (116) may be configured to evaluate the affinity algorithms (142) in the storage repository (130). The classification module (116) may also be configured to select and retrieve one of the affinity algorithms that likely lead to a correct categorization of the text description of an idea.

In one or more embodiments of the invention, the category module (108) is also configured to select a revised (and/or replacement) set of named categories. Specifically, when the target category to which the idea is classified is incorrect (as determined, for example, from feedback received from the user), the category module (108) may add a category to the set of named categories, delete a category from the set of named categories, create an entirely new set of named categories, or otherwise revise the set of named categories that were previously used for the search term.

The revised (and/or replacement) set of named categories may be used by the classification module (116) to determine a revised (and/or replacement) search algorithm. To create the revised (and/or replacement) set of named categories, the category module (108) may evaluate the affinity score for each named category from the set of named categories and revise the set of named categories based on one or more of the affinity scores for each named category.

In one or more embodiments of the invention, the search module (112) is also configured to process the results of each search. Processing the result of a search may be performed according to the search algorithm. For example, the search module (112) may process the results of each search by counting the number of results (e.g., web pages) that contain the terms (e.g., search term, named category) used in the search. Each result may be actually counted by the search module (112). Each result may also be set equal to the number of results reported for the search by the search engine used. The result of a search may also be processed in some other suitable manner, including but not limited to counting each web page in which the search terms, for example, appear at least ten times, only considering web pages that are no more than two years old, not counting web pages on a pre-determined list of excluded web pages, and only counting web pages from a list of pre-approved web pages.

Continuing with FIG. 1, the scoring engine (110) is configured to calculate each affinity score in accordance with one or more embodiments of the invention. Each affinity score calculated by the scoring engine (110) may be based on the affinity algorithm designated for a particular search.

Optionally, in one or more embodiments of the invention, the equivalent item list (144) is configured to determine an equivalent text description of an equivalent item. Specifically, in cases where the text description (and, consequently, the search term) of an item involved in the idea description is too narrow, than the equivalent item list (144) determines another item that is equivalent to the item involved in the idea.

Optionally, in one or more embodiments of the invention, the security module (128) is configured to secure interactions between the computer system (102) and the client device (150) and a search engine source (170). More specifically, the security module (128) may be configured to authenticate communication from software based on security keys verifying the identity of the source of the communication.

In one or more embodiments of the invention, one or more of the user software is configured to display web page(s) (i.e., web content). More specifically, the user software and search engine source software may be any software capable of rendering Hypertext Markup Language (HTML) in one or more embodiments of the invention.

Further, one or more elements of the aforementioned computer system (102) may be located at a remote location and connected to the other elements over a network. Further, embodiments of the invention may be implemented on a distributed system having a plurality of nodes, where each portion of the invention (e.g., classification module, category module, scoring engine) may be located on a different node within the distributed system. In one or more embodiments of the invention, the node corresponds to a computer system. Alternatively, the node may correspond to a processor with associated physical memory. The node may alternatively correspond to a processor with shared memory and/or resources.

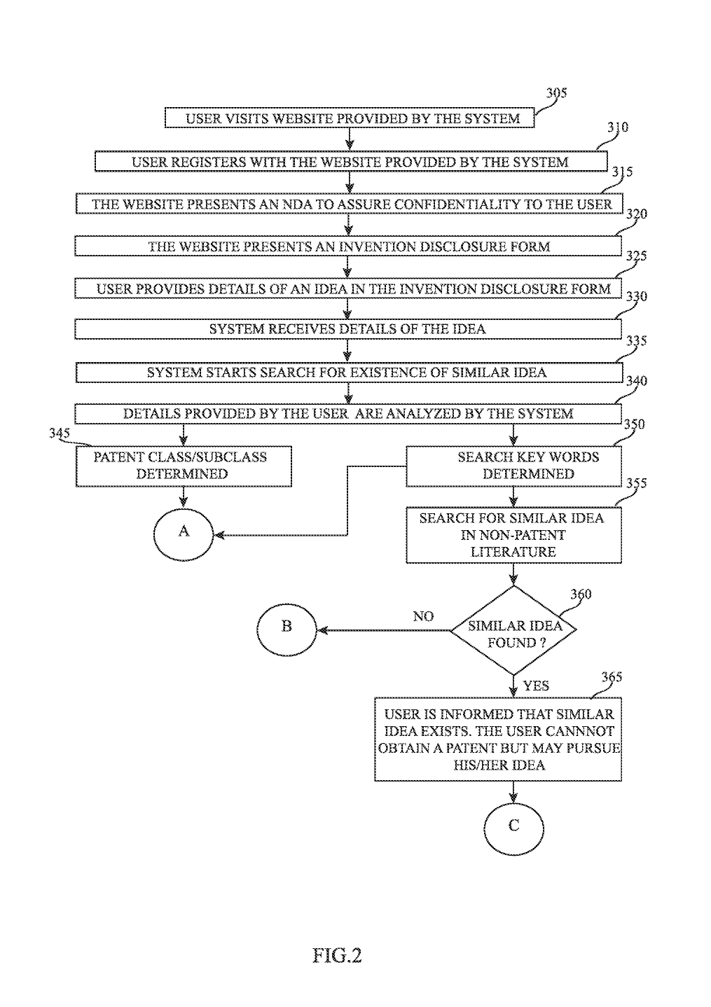

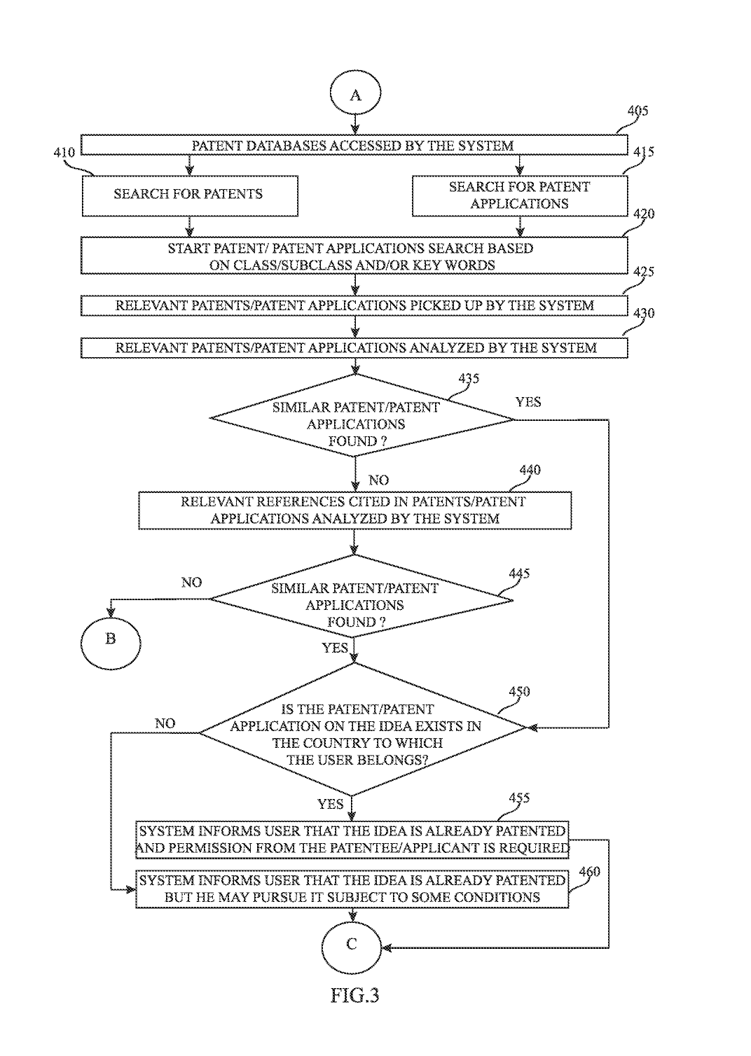

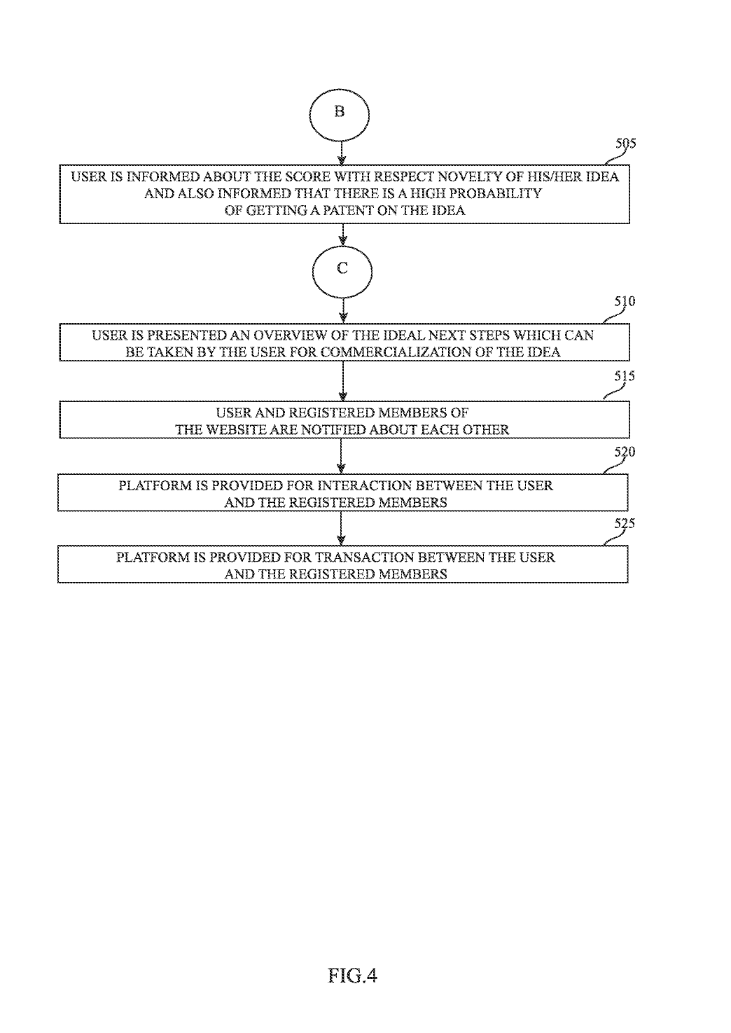

FIG. 2, FIG. 3 and FIG. 4 show flowcharts of a method for scoring of a new idea in accordance with one or more embodiments of the invention. While the various steps in these flowcharts are presented and described sequentially, some or all of the steps may be executed in different orders, may be combined or omitted, and some or all of the steps may be executed in parallel. Further, in one or more of the embodiments of the invention, one or more of the steps described below may be omitted, repeated, and/or performed in a different order. In addition, additional steps, omitted in FIGS. 2, 3 and 4, may be included in performing this method. Accordingly, the specific arrangement of steps shown in FIGS. 2, 3 and 4 should not be construed as limiting the scope of the invention.

Referring to FIG. 2, in Step 305 a user (162) visits the website using client device (150) which is provided by the system of the present invention using client device (150). In Step 310, the user (162) registers and logs into the webpage provided by the computer system (102) using client device (150) for scoring his/her idea. In Step 315, the website presents a non disclosure agreement to the user (162) to assure confidentiality to the user (162). When the user (162) is given an assurance that full confidentiality will be maintained, the user (162) will be able to disclose his/her idea without any hesitation. In Step 320, the website presents an Invention Disclosure Form (IDF) to the user (162) wherein the user (162) can provide details of his idea by filling up the IDF. In Step 325, the user (162) provides details of his/her idea in the IDF. While disclosing his/her idea in the IDF, the user (162), along with text description of his/her idea, can include diagrams, photographs, videos etc. to explain the idea. In Step 330, the computer system (102) receives details of the idea provided by the user through IDF. In Step 335, the computer system (102) starts preparation for search for existence of similar idea world-wide through search engine source (170).

In Step 340, search algorithm (140) reads and analyzes the input submitted by the user (162) about an idea. In Step 345, the classes/subclasses of the idea are determined as per standard patent classification using classification module (116) and Classes/subclasses associated with the idea are selected from category module (108). In one or more embodiments of the invention, an algorithm is used to derive a class and a sub-class as per standard patent classification from the text description and other details provided in the IDF. In one or more embodiments of the invention, a class/subclass is selected as a viable class/subclass into which the idea may be classified. One or more classes/subclasses may be selected. The classes/subclasses may be selected according to one of a number of algorithms. If more than one algorithm exists to select the classes/subclasses, one of the algorithms may be chosen based on the patent classification, past performance of an algorithm, user preferences, the system for which the idea is being classified, some other suitable factor, or any combination thereof. Each algorithm may function according to user preferences, default settings, prior experience with the patent classification, some other factor, or any suitable combination thereof. For example, an algorithm may initially evaluate all classes/subclasses in a list as patent classification. Alternatively, an algorithm may recognize the classes/subclasses and select certain class/subclass as patent classification. For example, if the idea is related to a “Multi-purpose dishwasher rack,” then an algorithm may select the patent classification as 220/485 and 211/41.8 wherein 220 and 211 are the classes and 485 and 41.8 are the subclasses. In an exemplary embodiment, as per US patent classification, class 220 means “receptacles” and sub class 485 means “wire container”. Similarly, class 211 means “supports: racks” and sub class 41.8 means “dishwashing machine rack”.

In Step 350, keywords are determined from the details provided by the user in the IDF. In one or more embodiments of the invention, an algorithm is used to derive the search term from details of the idea provided by the user through IDF. As discussed above, the algorithm may perform one or more functions, such as removing from the text description common words (e.g., the, a, an), removing adjectives, and removing prepositional phrases from the text description. If a search term is determined to be overly narrow or broad, the search term may be revised (and/or replaced) to generate a revised (and/or replacement) search term.

The search module (112) also performs patent search as well as a search in non-patent literature as in Step 355 for existence of similar ideas in public domain through search engine source (170) with the help of search algorithms (140). The affinity algorithms (142) then compare the idea. Based on the score generated by the scoring engine (110), if similar idea is found as in step 360, then the user is informed that similar idea already exists as in step 365. In step 365 the user (162) is also informed that although it may not be possible to obtain a patent on the idea it would be still possible for him/her to pursue the idea. If no similar idea is found then the user is informed about the score with respect to the novelty of his/her idea and also that there is a high probability of getting a patent on the idea if attempted in step 505.

The system also determines the search algorithm and the affinity algorithm. In one or more embodiments of the invention, the search algorithm and/or the affinity algorithm is based on the search term and/or the class/subclass. The search algorithm and/or affinity algorithm may be selected from a set of pre-approved search algorithms and/or affinity algorithms. The search algorithm may specify or suggest one or more search engines to use based on the search term and the set of named categories.

As best illustrated in FIG. 3, in Step 405, various patent databases of the world, both paid and open source, such as United States Patent and Trademark Office patent database, Canadian Intellectual Patent Office database, State Intellectual Property Office patent database, Indian Patent Office patent database, Dialog, Google patent etc. are accessed by the search module (112) through search engine source (170). In Step 410, the search module (112) searches for patents similar to the idea and in Step 415, the search module (112) search for patent applications similar to the idea. In Step 420, the search module (112) starts patent search and patent application search based on class/subclass, based on keywords and based on both class/subclass and keywords. In one or more embodiments of the invention, at least one algorithm is used to search for patents and patent applications.

In Step 420, the search may actually be a series of searches conducted according to the search algorithm. For example, for each of three different search engines, a search may be conducted for the search term, patent classification A, patent classification B, patent classification C, the search term and patent classification A, the search term and patent classification B, and the search term and patent classification C. In one or more embodiments of the invention, each patent classification paired with the search term in at least one search for each search engine. The pairings and/or searches for each search engine may be determined based on the affinity algorithm.

In Step 425, the system picks up the relevant searched patent/patent application documents for comparing with the description of the idea and checks for any similar idea among the searched patent/patent application documents. For example, the algorithm may pick up from the million search results, the most relevant results and check for any similar idea. Alternatively, the patent classification and search term pairs to find out the most relevant patent/patent application documents and check for any similar idea.

In Step 430, relevant patent and patent applications picked up the system are analyzed. A determination is made as to whether the results of the searches should be refined. Results of the searches may need refining if the results are inconsistent with expectations. For example, the results of the search may need refining if there are too few search results on a search engine, there are too many search results of a search on a search engine that are older than a certain threshold, and the results are inconsistent (e.g., there are more results for a search of “donuts food” than there are for a search of “donuts.”).

Analyzing of the results as in Step 430 may put the results of the various searches into a format usable for the affinity algorithm. For example, processing may involve screening a number of web pages and/or other references that generated a match in the search. The results of the search may be processed in other ways and/or by using filters. For example, search results may be filtered by processing web pages that have been posted within the past one or two years and/or that come from one of a list of pre-approved web sites. Examples of processing the results of the search in other ways include, but are not limited to counting web pages that have at least ten occurrences of the search term.

In Step 430, an affinity score is also calculated by scoring engine (110) with the help of affinity algorithm 142. In one or more embodiments of the invention, the affinity score is a threshold used to determine which patent or patent application of the set of search results are most likely to be relevant to the idea description.

In Step 430, the affinity score for each patent or patent application is evaluated. In one or more embodiments of the invention, evaluating the affinity score for each patent or patent application may lead to a determination that a revised or replaced affinity algorithm is warranted.

Further, a revised (and/or replacement) search term may also be generated to replace the previously-used search term. In one or more embodiments of the invention, the revised (and/or replacement) search term may be generated in a manner substantially similar to the manner in which the previously-used search term is generated, as described above with respect to Step 350. The revised (and/or replacement) search term may be broader than, narrower than, or otherwise different from the previously-used search term. In one or more embodiments of the invention, a particular computing device, as described, for example, in FIG. 1 above, is used to generate a revised (and/or replacement) set of search terms.

Based on the affinity score determined at step 430, between the search result and the idea description, the system determines at step 435 if the patent or patent application found in the search is similar to the described idea.

If similar patent/patent applications are found as in Step 435, then the system checks if the similar patent/patent applications found on the idea is granted/applied in the same country to which the user trying the idea belongs in Step 450.

If no similar patent/patent application is found as in Step 435, then the system starts analyzing the references cited in the relevant patent/patent applications in Step 440 the same way as is does in step 430. If similar patent/patent applications are found as in Step 445, then the system checks if the similar patent/patent applications found on the idea is granted/filed in the same country to which the user belongs in Step 450. In a preferred embodiment of the present invention if no similar patent/patent applications are found as in Step 445, then the user is informed about the score with respect to the novelty of his/her idea as calculated in step 430 and also that there is a high probability of getting a patent on the idea if attempted in step 505.

If in Step 450, it is found that similar idea is patented or a patent is pending in the country to which the user belongs, then the user is informed in Step 455 that he/she cannot go ahead with patenting of his/her idea. But, at the same time, he/she would be informed that he/she can approach the patentee or the applicant for patent for a license in order to pursue his/her idea in that country. In a preferred embodiment user (162) would also be informed about whom to contact for patent licensing in case if he/she so desires.

On the other hand, if in Step 450 it is found that similar idea is patented or a patent is pending in a different country and not in the country to which the user belongs, then the user is informed in Step 460 that he/she cannot go ahead with patenting his idea as it is already patented in a different country. The user will be informed that he/she can still pursue his/her idea in his/her own country as he/she won't be sued for infringement since there is no patent granted or patent application pending in his/her country.

In step 510 the user 162 would be presented an overview of the ideal next steps to commercialize his/her idea. The user is presented with an educational video/flow chart of each step/process required before commercializing his/her idea. Additionally the system will consist of paid members network in many areas with a range of costs which are pre negotiated between scoring website and the members. Given below is a non-exhaustive list of such members who can get registered with the website provided by the computer system (102):
a) Intellectual Property Rights professionals
b) Venture Capitalists
c) Angel investors
d) Attorneys helping with incorporating
e) Crowdsources
f) Kickstarters
g) Entrepreneurs assisting enterprises
h) Freelancers
i) Any other members who can provide help from a product manufacturing and services standpoint e.g. website site registration, manufactures list etc.

In step 515 a platform is provided between the user of the website and all or some of the above mentioned members to interact with each other. The members will be notified once the scoring is completed against an idea submitted by the user. In some other embodiments such notifications are triggered when a score crosses a particular threshold set in the profiles of the said members. The user is also notified that there exist a pool of members registered with the website who can help him/her in different phases of turning the idea into reality if he/she so desires.

In step 520 the members may be asked to pay a nominal fee before the inventor's or user's contact is shared with the network members. Again, in some embodiments of the present invention a commission is deducted from the fees paid to the said members such as attorneys and angel investors during any financial transaction.

In a preferred embodiment the system will also keep track of the progress of the idea and use it as marketing leads for the future.

Having described the system and method of the present invention, its advantages will now be described. The system analyses an idea within few minutes. The system provides a comprehensive and detailed report for the idea based on which the user can take the decision as to how to pursue his/her idea. As the system collects data from highly reliable data sources so the user can rely on the score provided by the system. Boost to new innovation and ideas to come up faster. The system provides a platform network to investors and inventors to contribute and pursue the ideas. In some preferred embodiments of the present invention the user of the system can be provided suggestion about the following:
a) How successful the idea would be if taken to the Market.
b) Provide reference of similar ideas already in play or upcoming
c) Also provide numbers on how many people in the world who might be thinking on the same lines.
d) How close someone is to implement the idea.
e) What are the chances that someone will be able to implement one's idea?
f) Provide steps on how to go about making the idea into reality.
g) Give suggestion if he/she should stay in stealth mode or go to venture capitalists.
h) How long the idea would take to build and how long will it sustain in the market.
i) How much investment might be needed to pursue this idea and a breakdown of the costs?
j) What will be the potential revenue/profit of the idea?

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for scoring of a new idea, said system comprising:
one or more client devices;
one or more search engine sources; and
at least one computer system communicatively connected to said one or more client devices through a network, said at least one computer systems having one or more modules, said one or more modules configured to execute, at least;
receiving of details of an idea from a user through said one or more client devices;
searching for existence of one or more ideas similar to said idea;
providing of information on a result of said search to said user through said one or more client devices; and
providing of suggestion based on said result to said user through said one or more client devices.

2. The system for scoring of a new idea as in claim 1, wherein said one or more modules of said at least one computer system includes an idea analysis module, a storage repository, a processor, a memory, an application interface and a security module.

3. The system for scoring of a new idea as in claim 2, wherein said idea analysis module further comprises of a classification module, a category module, a scoring engine and a search module.

4. The system for scoring of a new idea as in claim 3, wherein said at least one computer system retrieves and stores in said storage repository a text description, a category list, a prior result, an algorithm having a search algorithm and an affinity algorithm and an equivalent item list.

5. The system for scoring of a new idea as in claim 1, wherein said at least one search engine source sends patent and non-patent literature and other information and receives information from said at least one computer system.

6. The system for scoring of a new idea as in claim 1, wherein a user software and a search engine source software interact directly with said at least one computer system as a browser extension.

7. The system for scoring of a new idea as in claim 2, wherein said at least one computer system interacts with said at least one client device and said at least search engine source using said application interface.

8. The system for scoring of a new idea as in claim 2, wherein said application interface is configured to receive input from and send output to said at least one client device and said at least one search engine source.

9. The system for scoring of a new idea as in claim 4, wherein said storage repository includes one or more text descriptions of one or more ideas entered by a plurality of past users that have been previously categorized.

10. The system for scoring of a new idea as in claim 4, wherein said category list include a list of categories used when classifying an idea.

11. The system for scoring of a new idea as in claim 1, wherein said result provided by said at least one computer system against submission of said idea by said user are in terms of numerical scores.

12. The system for scoring of a new idea as in claim 4, wherein said search algorithm extracts key words from description provided by said user to conduct a search based on key words, compare relatedness of input with search results found and score based on said relatedness.

13. The system for scoring of a new idea as in claim 4, wherein said affinity algorithm of said algorithm in said storage repository includes a procedure to calculate an affinity score with the help said scoring engine.

14. The system for scoring of a new idea as in claim 4, wherein said classification module uses at least one said algorithm to generate said search term from said text description.

15. The system for scoring of a new idea as in claim 13, wherein said classification module is further configured to select said affinity algorithm to calculate one or more said affinity scores based on a comparison between details entered by said user with search results.

16. The system for scoring of a new idea as in claim 10, wherein said category module is configured to select a revised set of named said categories.

17. The system for scoring of a new idea as in claim 16, wherein the revised set of named said categories is used by said classification module to determine a revised said search algorithm.

18. The system for scoring of a new idea as in claim 13, wherein said scoring engine is configured to calculate said each affinity score and said each affinity score calculated by said scoring engine is based on said affinity algorithm designated for a particular search.

19. A method for scoring of a new idea in a system, said system comprising one or more client devices, one or more search engine sources, at least one computer system communicatively connected to said one or more client devices through a network, said at least one computer systems having one or more modules, said one or more modules configured to execute, at least one request, said method comprising the steps of:
receiving of details of an idea from a user through said one or more client devices;
searching for existence of one or more ideas similar to said idea;
providing of information on a result of said search to said user through said one or more client devices; and
providing of suggestion based on said result to said user through said one or more client devices.

20. The method for scoring of a new idea in a system as in claim 19, wherein said suggestion provided to said user includes suggestion on how successful said idea would be if taken to market, what are the chances that someone will be able to implement said idea, provide steps on how to go about making said idea into reality, how much investment might be needed to pursue said idea and a breakdown of costs and what will be the potential revenue from said idea.
